(19) United States
(12) Patent Application Publication
(10) Pub. No.: US 2026/0353405 A1
(43) Pub. Date: Nov. 5, 2026

(54) FLEXIBLE DOWNLINK CONTROL INFORMATION FORMAT

(71) Applicant: QUALCOMM Incorporated, San Diego, CA (US)

(72) Inventors: Gabi SARKIS, San Diego, CA (US); Mostafa KHOSHNEVISAN, San Diego, CA (US); Weimin DUAN, San Diego, CA (US); Diana MAAMARI, San Diego, CA (US); Kangqi LIU, Irvine, CA (US); Morteza SOLTANI, San Diego, CA (US); Peter GAAL, San Diego, CA (US)

(21) Appl. No.: 19/662,867

(22) Filed: Apr. 29, 2026

Related U.S. Application Data
(60) Provisional application No. 63/799,156, filed on May 2, 2025.

(51) Int. Cl. H04W 72/232

(52) U.S. Cl. CPC H04W 72/232

(57) ABSTRACT

Various aspects of the present disclosure generally relate to wireless communication. In some aspects, a user equipment (UE) may receive, from a network node, a configuration that indicates a functionality for a downlink control information (DCI) format configuration, the functionality associated with a configuration condition. The UE may monitor a physical downlink control channel (PDCCH) candidate for a DCI message associated with the DCI format configuration based on whether the configuration satisfies the configuration condition associated with the functionality. Numerous other aspects are described.

### CROSS-REFERENCE TO RELATED APPLICATION

This patent application claims priority to U.S. Provisional Patent Application No. 63/799,156, filed on May 2, 2025, entitled “FLEXIBLE DOWNLINK CONTROL INFORMATION FORMAT,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with a flexible downlink control information format.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Downlink control information (DCI) includes control messages or instructions that a network node transmits to a user equipment (UE) to manage and allocate radio resources or otherwise ensuring efficient and effective communication between the network node and the UE. For example, DCI is often used to schedule downlink, uplink, or sidelink transmissions, and to indicate parameters such as time and frequency resources allocated to a scheduled transmission, a modulation and coding scheme (MCS) for the transmission, or multiple-input multiple-output (MIMO) layers for the transmission, among other examples. In other examples, DCI may be used to indicate configuration information for a communication link or other non-scheduling purpose, such as switching a transmission configuration indication (TCI) state, configuring or switching a bandwidth part (BWP), or setting parameters for beamforming or MIMO operations, among other examples. Each DCI message that a network node transmits to a UE is associated with a DCI format that indicates the structure (e.g., fields and associated sizes) and the purpose for the DCI message (e.g., uplink scheduling, downlink scheduling, sidelink scheduling, multicast scheduling, or configuration).

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a network node, a configuration that indicates a functionality for a downlink control information (DCI) format configuration, the functionality associated with a configuration condition. The processing system may be configured to cause the UE to monitor a physical downlink control channel (PDCCH) candidate for a DCI message associated with the DCI format configuration based on whether the configuration satisfies the configuration condition associated with the functionality.

Some aspects described herein relate to a network node. The network node may include a processing system. The processing system may include one or more processors and one or more code-storing memories coupled with the one or more processors. The processing system may be configured to cause the network node to transmit, to a UE, an configuration that indicates a functionality for a DCI format configuration, wherein the configuration indicates one or more fields or values that satisfy a configuration condition associated with the functionality. The processing system may be configured to cause the network node to transmit, to the UE via a PDCCH candidate, a DCI message associated with the DCI format configuration.

Some aspects described herein relate to a method of wireless communication performed by a UE. The method may include receiving, from a network node, a configuration that indicates a functionality for a DCI format configuration, the functionality associated with a configuration condition. The method may include monitoring a PDCCH candidate for a DCI message associated with the DCI format configuration based on whether the configuration satisfies the configuration condition associated with the functionality.

Some aspects described herein relate to a method of wireless communication performed by a network node. The method may include transmitting, to a UE, a configuration that indicates a functionality for a DCI format configuration, wherein the configuration indicates one or more fields or values that satisfy a configuration condition associated with the functionality. The method may include transmitting, to the UE via a PDCCH candidate, a DCI message associated with the DCI format configuration.

Some aspects described herein relate to a non-transitory computer-readable medium that stores a set of instructions for wireless communication by a UE. The set of instructions, when executed by one or more processors of the UE, may cause the UE to receive, from a network node, a configuration that indicates a functionality for a DCI format configuration, the functionality associated with a configuration condition. The set of instructions, when executed by one or more processors of the UE, may cause the UE to monitor a PDCCH candidate for a DCI message associated with the DCI format configuration based on whether the configuration satisfies the configuration condition associated with the functionality.

Some aspects described herein relate to a non-transitory computer-readable medium that stores a set of instructions for wireless communication by a network node. The set of instructions, when executed by one or more processors of the network node, may cause the network node to transmit, to a UE, a configuration that indicates a functionality for a DCI format configuration, wherein the configuration indicates one or more fields or values that satisfy a configuration condition associated with the functionality. The set of instructions, when executed by one or more processors of the network node, may cause the network node to transmit, to the UE via a PDCCH candidate, a DCI message associated with the DCI format configuration.

Some aspects described herein relate to an apparatus for wireless communication. The apparatus may include means for receiving, from a network node, a configuration that indicates a functionality for a DCI format configuration, the functionality associated with a configuration condition. The apparatus may include means for monitoring a PDCCH candidate for a DCI message associated with the DCI format configuration based on whether the configuration satisfies the configuration condition associated with the functionality.

Some aspects described herein relate to an apparatus for wireless communication. The apparatus may include means for transmitting, to a UE, a configuration that indicates a functionality for a DCI format configuration, wherein the configuration indicates one or more fields or values that satisfy a configuration condition associated with the functionality. The apparatus may include means for transmitting, to the UE via a PDCCH candidate, a DCI message associated with the DCI format configuration.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example wireless communication network.

FIG. 2 illustrates an example associated with modular downlink control information (DCI).

FIG. 3 illustrates an example associated with a flexible DCI format.

FIG. 4 illustrates examples associated with a flexible DCI format configuration that indicates one or more functionalities.

FIG. 5 illustrates examples associated with a flexible DCI format configuration associated with a search space.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIG. 8 is a diagram of an example apparatus for wireless communication.

FIG. 9 is a diagram of an example apparatus for wireless communication.

### DETAILED DESCRIPTION

In some wireless communication systems, downlink control information (DCI) is used to convey scheduling and control information between a network node and a user equipment (UE). DCI formats are defined in wireless communication standards, and include various fields that provide specific functionalities, such as resource allocation, bandwidth part (BWP) switching, and multiple-input multiple-output (MIMO) configuration, among others. For example, DCI formats 0_x are used to schedule uplink transmissions and include fields such as a frequency domain resource assignment (FDRA) field, a time domain resource assignment (TDRA) field, a frequency hopping flag, and a modulation and coding scheme (MCS) field, among other examples, and DCI formats 1_x are used to schedule downlink transmissions and include fields such as an FDRA field, a TDRA field, a virtual resource block to physical resource block (VRB-to-PRB) mapping field, and a hybrid automatic repeat request (HARQ) process number field, among other examples. The fields associated with a DCI format serve an important role to enable a UE to interpret and apply commands received from the network node. However, DCI formats are defined according to a rigid framework, which introduces several challenges.

For example, the number of DCI formats specified in wireless communication standards has grown substantially, with there currently being 24 distinct formats (e.g., four DCI formats, indexed 0_0 through 0_3, for uplink scheduling, four DCI formats, indexed 1_0 through 1_3, for downlink scheduling, ten DCI formats, indexed 2_0 through 2_9, for group common configurations, three DCI formats, indexed 3_0 through 3_2, for sidelink scheduling, and three DCI formats, indexed 4_0 through 4_2, for multicast scheduling). Many fields within the specified DCI formats are dynamically configured based on network parameters, such as the number of configured BWPs or whether certain functionalities are enabled, and DCI fields can have different sizes or may be omitted from a DCI message entirely depending on a configuration (e.g., an FDRA field has a variable size depending on the parameter used to indicate the FDRA and/or the number of resource blocks in a BWP, and a synchronization signal block (SSB) index field may be omitted from a DCI message that triggers a random access procedure if the DCI message includes a non-zero value in a random access preamble index field). While the variable sizes and/or fields in a DCI format provides some flexibility, the variability in DCI formats creates challenges when introducing new DCI functionalities or modifying DCI formats to support new functionalities or parameters. For instance, when a wireless communication standard adopts a new parameter that can indicate a value for a particular DCI field, corresponding updates are propagated across different sections or specifications of the standards and DCI sizes need to be adjusted to ensure that the UE can properly detect and decode the DCI field.

Furthermore, having fixed DCI format configurations may lead to an increased DCI payload size, which reduces spectral efficiency. For example, although certain DCI fields can be omitted from a DCI message, the omission often relies on default values that are specified in wireless communication standards, which may not align with deployment-specific requirements. Accordingly, when a default value is changed to accommodate deployment-specific requirements (e.g., certain UEs supporting a feature and other UEs not supporting the feature), the change to the default value has to be propagated throughout the specifications, which is not feasible in every deployment scenario. Additionally, fields such as BWP indices derive a size from a configured set of candidate values, which can lead to a larger than necessary payload size. For example, where two different DCI formats share the same set of BWPs, the size of the BWP index field for one DCI format may be larger than necessary, even when one format requires fewer options. In addition, DCI formats are often managed within a search space, which introduces additional complexity. For example, search spaces define aggregation levels and candidate configurations for DCI monitoring (e.g., the number of physical downlink control channel (PDCCH) candidates monitored for a given DCI format), which apply uniformly across all DCI formats that are monitored within the search space. The uniformity can be limiting when different DCI formats have varying requirements for aggregation levels. For example, a smaller, highly dynamic DCI format might benefit from a different aggregation level than a larger, complex DCI format. The lack of granularity in aggregation level configuration can lead to suboptimal monitoring and resource allocation.

Various aspects relate generally to enabling flexible DCI formats in a wireless communication system. Some aspects more specifically relate to a network node transmitting, and a UE receiving, a configuration for a flexible DCI format (e.g., a radio resource control (RRC) configuration, or other suitable signaling), where the flexible DCI format configuration includes one or more functionalities. For example, in some aspects, each functionality associated with a flexible DCI format defines a set of fields or parameter values to implement a communication function, such as a MIMO configuration, downlink or uplink scheduling, BWP switch, or search space set group (SSSG) switching, among other examples. Accordingly, in some aspects, each functionality that can be configured for the flexible DCI format is associated with a configuration condition (e.g., a set of requirements) related to one or more fields or values that provide the minimum parameters to support the associated functionality. In some aspects, when a flexible DCI format configuration is associated with a functionality, the one or more fields or values that provide the minimum parameters to support the associated functionality may be configured within the flexible DCI format configuration, or within a separate parameter configuration linked to the flexible DCI format configuration via an identifier. In some aspects, in cases where the flexible DCI format is misconfigured (e.g., one or more minimum parameters are not configured, or associated with multiple configurations), the UE may refrain from monitoring PDCCH candidates associated with the (misconfigured) flexible DCI format. Furthermore, in some aspects, a flexible DCI format configuration is associated with a search space that indicates the PDCCH candidates to monitor for a DCI message associated with the flexible DCI format configuration. For example, the flexible DCI format may be configured within a configuration for the search space, or the search space may be separately configured and linked to the flexible DCI format via an identifier. Furthermore, the flexible DCI format configuration may indicate the PDCCH candidates to monitor for the flexible DCI format configuration for one or more aggregation levels. In cases where the associated search space also configures PDCCH candidates for one or more aggregation levels, the aggregation level candidates configured for the flexible DCI format may override or supplement the aggregation level candidates configured for the search space.

Particular aspects of the subject matter described in this disclosure can be implemented to realize one or more of the following advantages. In some examples, by introducing a flexible DCI format, the described techniques may enable dynamic interpretation of field requirements (e.g., supporting different parameters that can indicate a value for a DCI field), thereby reducing computational complexity. In addition, the described techniques can reduce signaling overhead or increase spectral efficiency, because techniques such as omitting unused fields, aligning field sizes according to deployment-specific requirements, or indicating a value for a DCI field using a parameter with a smaller bit length can be used to reduce a payload size for the flexible DCI format. In this way, the described techniques may conserve network resources, such as bandwidth, while maintaining compatibility with evolving system deployments. Furthermore, by associating flexible DCI formats with tailored aggregation levels, the described techniques enable more granular control over PDCCH monitoring tailored to each flexible DCI format instance, which improves resource allocation and scheduling efficiency for different DCI formats, conserves processing resources and memory resources at the UE and the network node by avoiding redundant monitoring efforts, and reducing the computational load. Further, by addressing error handling through configuration conditions associated with configured functionalities, some aspects described herein reduce a risk of misconfiguration and ensure predictable UE behavior and enhanced system reliability when a misconfiguration does occur. For instance, a UE may avoid monitoring PDCCH candidates associated with invalid flexible DCI format instances, thereby conserving resources that would otherwise be consumed monitoring for a DCI message associated with an invalid configuration.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

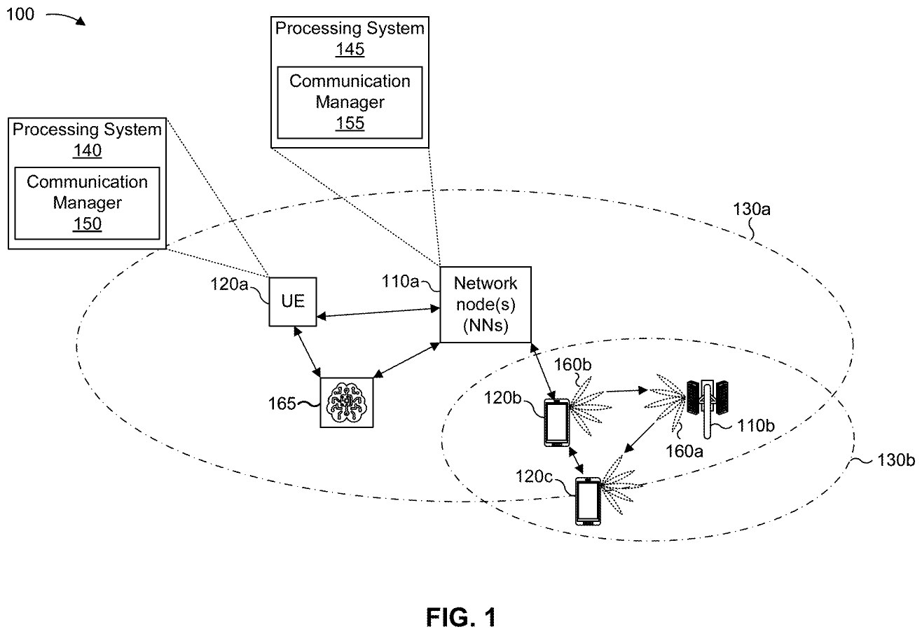

FIG. 1 is a diagram illustrating an example wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHZ), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into BWPs. A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters. Different DCI formats carry different information, such as scheduling information in the form of downlink or uplink grants, slot format indicators (SFIs), preemption indicators (PIs), transmit power control (TPC) commands, HARQ information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, from a network node 110, a configuration that indicates a functionality for a DCI format configuration, the functionality associated with a configuration condition; and monitor a PDCCH candidate for a DCI message associated with the DCI format configuration based on whether the configuration satisfies the configuration condition associated with the functionality. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, a configuration that indicates a functionality for a DCI format configuration, wherein the configuration indicates one or more fields or values that satisfy a configuration condition associated with the functionality; and transmit, to the UE 120 via a PDCCH candidate, a DCI message associated with the DCI format configuration. Additionally, or alternatively, the communication manager 155 may perform one or more other operations described herein.

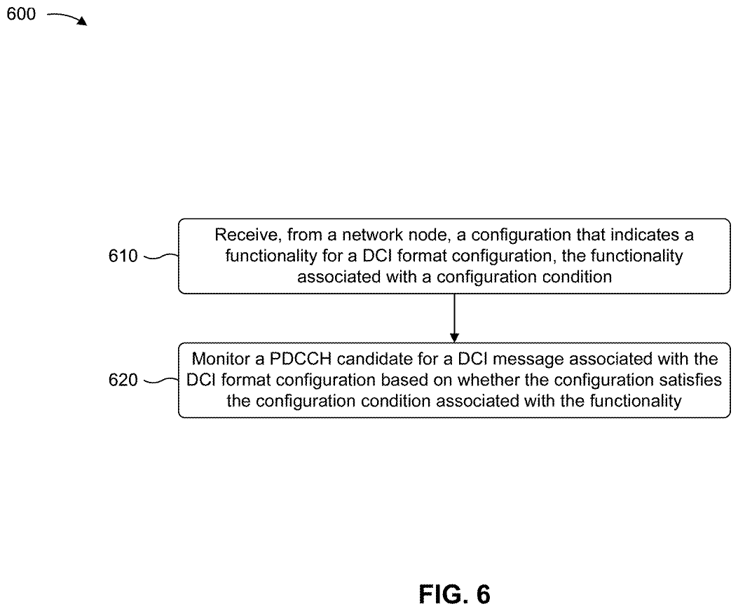

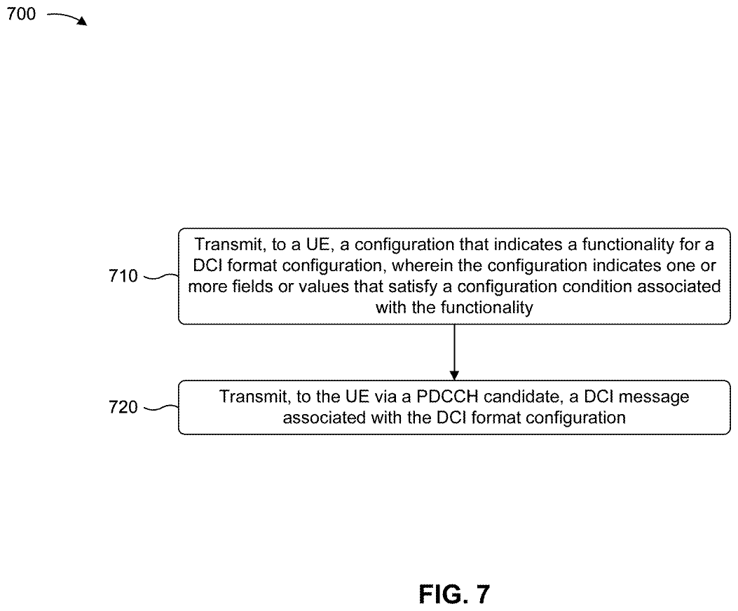

The network node 110, the processing system 145 of the network node 110, the UE 120, the processing system 140 of the UE 120, or any other component(s) of FIG. 1 may implement one or more techniques or perform one or more operations associated with a flexible DCI format, as described in more detail elsewhere herein. For example, the processing system 145 of the network node 110, or the processing system 140 of the UE 120 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

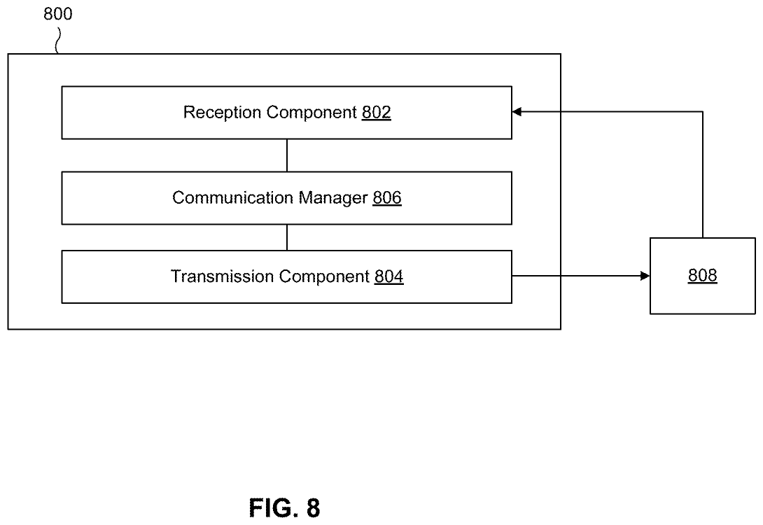

In some aspects, the UE 120 includes means for receiving, from a network node 110, a configuration that indicates a functionality for a DCI format configuration, the functionality associated with a configuration condition; or means for monitoring a PDCCH candidate for a DCI message associated with the DCI format configuration based on whether the configuration satisfies the configuration condition associated with the functionality. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

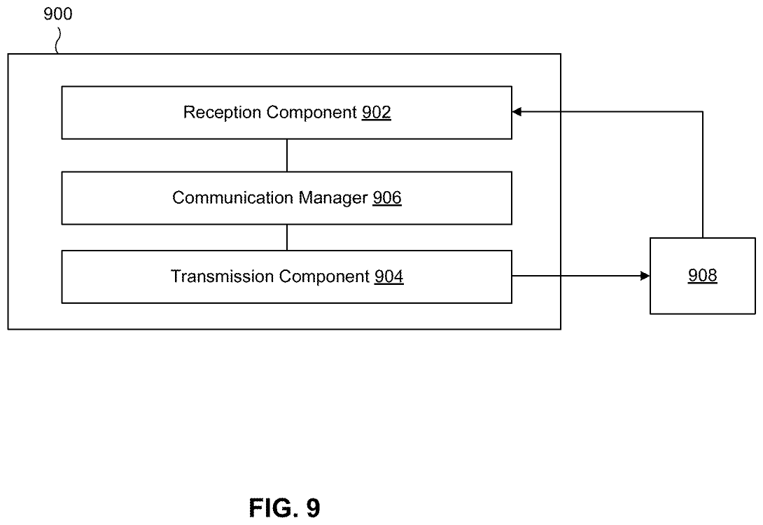

In some aspects, the network node 110 includes means for transmitting, to a UE 120, a configuration that indicates a functionality for a DCI format configuration, wherein the configuration indicates one or more fields or values that satisfy a configuration condition associated with the functionality; or means for transmitting, to the UE 120 via a PDCCH candidate, a DCI message associated with the DCI format configuration. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

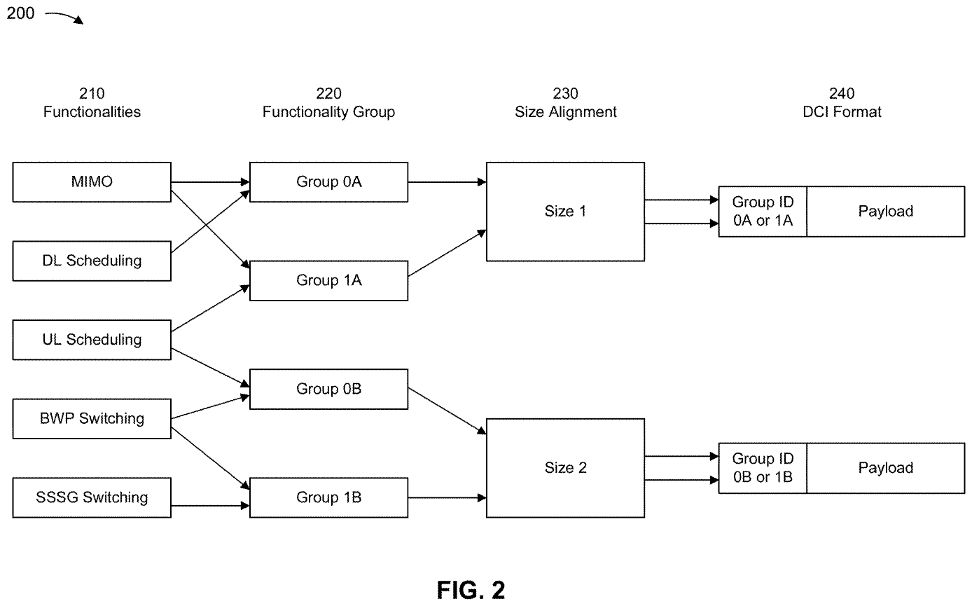

FIG. 2 illustrates an example 200 associated with modular DCI. More particularly, as described herein, DCI is generally used to convey scheduling and control information between a network node 110 and a UE 120. DCI formats are defined in wireless communication standards, and include various fields that provide specific functionalities, such as resource allocation, BWP switching, and MIMO configuration, among others. The fields associated with a DCI format serve an important role to enable a UE 120 to interpret and apply commands received from the network node 110. However, DCI formats are defined according to a rigid framework, which introduces several challenges. For example, the number of DCI formats specified in wireless communication standards has grown substantially, with there currently being 24 distinct formats (e.g., four DCI formats, indexed 0_0 through 0_3, for uplink scheduling, four DCI formats, indexed 1_0 through 1_3, for downlink scheduling, ten DCI formats, indexed 2_0 through 2_9, for group common configurations, three DCI formats, indexed 3_0 through 3_2, for sidelink scheduling, and three DCI formats, indexed 4_0 through 4_2, for multicast scheduling). Many fields within the specified DCI formats are dynamically configured based on network parameters, such as the number of configured BWPs or whether certain functionalities are enabled, and DCI fields can have different sizes or may be omitted from a DCI message entirely depending on a configuration. While the variable sizes and/or fields in a DCI format provides some flexibility, the variability in DCI formats creates challenges when introducing new DCI functionalities or modifying DCI formats to support new functionalities or parameters. For instance, when a wireless communication standard adopts a new parameter that can indicate a value for a particular DCI field, corresponding updates are propagated across the standards and DCI sizes need to be adjusted to ensure that the UE 120 can properly detect and decode the DCI field.

Furthermore, having fixed DCI format configurations may lead to an increased DCI payload size, which reduces spectral efficiency. For example, although certain DCI fields can be omitted from a DCI message, the omission often relies on default values that are specified in wireless communication standards, which may not align with deployment-specific requirements. Accordingly, when a default value is changed to accommodate deployment-specific requirements (e.g., certain UEs 120 supporting a feature and other UEs 120 not supporting the feature), the change to the default value has to be propagated throughout the specifications, which is not feasible in every deployment scenario. Additionally, fields such as BWP indices derive a size from a configured set of candidate values, which can lead to a larger than necessary payload size. For example, where two different DCI formats share the same set of BWPs, the size of the BWP index field for one DCI format may be larger than necessary, even when one format requires fewer options. In addition, DCI formats are often managed within a search space, which introduces additional complexity. For example, search spaces define aggregation levels and candidate configurations for DCI monitoring (e.g., the number of PDCCH candidates monitored for a given DCI format), which apply uniformly across all DCI formats that are monitored within the search space. The uniformity can be limiting when different DCI formats have varying requirements for aggregation levels. For example, a smaller, highly dynamic DCI format might benefit from a different aggregation level than a larger, complex DCI format. The lack of granularity in aggregation level configuration can lead to suboptimal monitoring (e.g., increased power consumption) and/or resource allocation.

Accordingly, as shown in FIG. 2, a modular DCI framework may be used to indicate control information for one or more functionalities 210, where each functionality 210 corresponds to a configuration related to communication or operation by the UE 120. For example, the functionalities 210 may include scheduling functionalities, such as downlink scheduling, uplink scheduling, sidelink scheduling, and multicast scheduling, and the functionalities 210 may additionally include non-scheduling functionalities, such as configuring MIMO operation, BWP switching, and SSSG switching. In addition, the functionalities 210 may relate to other communication or operational configurations, such as a TCI state change, PDCCH skipping, secondary cell (SCell) dormancy, HARQ-acknowledgement codebook retransmission, PDCCH order triggering PRACH, semi-persistent scheduling (SPS) or configured grant (CG) release, SRS triggering, uplink TPC commands, indicating a slot format, or providing an indication related to an NES mode, among other examples. As described herein, each functionality 210 is associated with one or more fields that define minimum parameters to support the associated functionality 210. For example, functionalities 210 for downlink and uplink scheduling may be associated with FDRA, TDRA, MCS, NDI, redundancy version (RV), HARQ process number fields, and/or other fields that are used to indicate corresponding values to enable the UE 120 to transmit or receive a scheduled PxSCH.

In some aspects, as further shown in FIG. 2, the modular DCI framework is associated with a set of functionality groups 220, where each functionality group 220 is associated with one or more functionalities 210 and each functionality 210 can belong to one or more functionality groups 220. For example, the functionality groups 220 may include functionalities 210 associated with fields that may be used together, such as functionalities 210 for a MIMO configuration and downlink scheduling being combined within a functionality group 220 (e.g., Group 0A) to allow downlink scheduling with MIMO parameters. In other examples, functionalities 210 for a MIMO configuration and uplink scheduling may be combined within a functionality group 220 (e.g., Group 1A), functionalities 210 for uplink scheduling and BWP switching may be combined within a functionality group 220 (e.g., Group 0B), and functionalities 210 for BWP switching and SSSG switching may be combined within a functionality group 220 (e.g., Group 1B). In some aspects, the functionalities 210 and/or the functionality groups 220 may be defined in a wireless communication standard, or a network node 110 may transmit information to a UE 120 to indicate the functionalities 210 and/or the functionality groups 220. For example, each functionality 210 may be associated with an identifier that is indicated to the UE 120 or defined in a wireless communication standard, and configuration information provided to the UE 120 may indicate one or more of the identifiers of the functionalities 210 associated with a functionality group 220. In this way, the modular DCI framework may be easily extended to additional functionalities 210, and functionalities 210 may be dynamically grouped to improve network performance by managing resources and adapting to varying conditions (e.g., functionalities 210 may be added to or removed from one or more functionality groups 220, or new functionality groups 220 may be defined or configured to enhance adaptability for more efficient resource usage and improved performance).

As further shown in FIG. 2, grouping the functionalities 210 within the functionality groups 220 may facilitate size alignment 230, which optimizes the payload structure by aligning DCI format sizes to specific parameters or deployment-specific requirements. For example, different functionality groups 220 may associated with the same size alignment 230 (e.g., the same payload size) in accordance with the fields that define the minimum parameters for the functionalities 210 within the functionality groups 220. In other words, the size alignment 230 occurs at a level of the functionality groups 220. For example, as shown, Group 0A and Group 1A are associated with a first DCI size, and Group 0B and Group 1B are associated with a second DCI size. In this way, the UE 120 can monitor for DCI messages associated with the appropriate DCI size, which allows the UE 120 to decode and interpret the DCI messages.

Accordingly, as shown in FIG. 2, the modular DCI framework is associated with one or more DCI formats 240, where each DCI format 240 has a particular DCI size alignment 230, and each DCI format 240 indicates control information for one or more functionalities 210 associated with a functionality group 220 that is mapped to the DCI size alignment 230. In this way, the size alignment 230 ensures that the DCI format 240 matches a payload size that the UE 120 is configured to decode, reducing decoding errors and retransmissions, reducing overhead, and enhancing spectral efficiency. Furthermore, in examples where a DCI format 240 is associated with a size alignment 230 that is mapped to multiple functionality groups 220, a DCI message associated with the DCI format 240 includes a group identifier field to indicate the functionality group 220 associated with the DCI message. For example, in FIG. 2, the DCI format 240 mapped to Groups 0A and 1A includes a group identifier field to indicate whether a DCI message associated with the DCI format 240 indicates control information for one more functionalities 210 in Group 0A and or one more functionalities 210 in Group 1A. Alternatively, in examples where a DCI format 240 is associated with a size alignment 230 that is mapped to one functionality group 220, the group identifier field may be omitted from the DCI format 240.

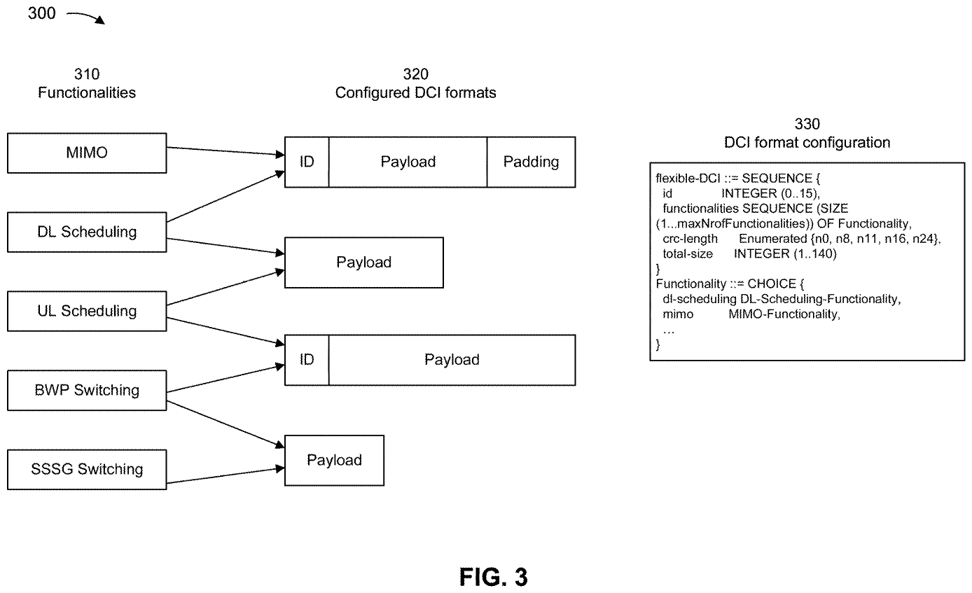

FIG. 3 illustrates an example 300 associated with a flexible DCI format. More particularly, example 300 relates to a flexible DCI format that may be used to indicate control information for one or more functionalities 310, where each functionality 310 corresponds to a configuration related to communication or operation by the UE 120. For example, the functionalities 310 may include scheduling functionalities, such as downlink scheduling, uplink scheduling, sidelink scheduling, and multicast scheduling, and the functionalities 310 may additionally include non-scheduling functionalities, such as configuring MIMO operation, BWP switching, and SSSG switching. In addition, the functionalities 310 may relate to other communication or operational configurations, such as a TCI state change, PDCCH skipping, SCell dormancy, HARQ-acknowledgement codebook retransmission, PDCCH order triggering PRACH, SPS or CG release, SRS triggering, uplink TPC commands, indicating a slot format, or providing an indication related to an NES mode, among other examples. As described herein, each functionality 310 is associated with one or more fields that define minimum parameters to support the associated functionality 310. For example, functionalities 310 for downlink and uplink scheduling may be associated with FDRA, TDRA, MCS, NDI, RV, HARQ process number fields, and/or other fields that are used to indicate corresponding values to enable the UE 120 to transmit or receive a scheduled PxSCH.

In some aspects, a network node 110 may transmit, and a UE 120 may receive, a configuration for one or more instances of a flexible DCI format 320 (e.g., an RRC configuration, although other suitable signaling may be used). For example, as shown in FIG. 3 and described herein, each instance of the flexible DCI format 320 is associated with one or more functionalities 310. In this way, one or more functionalities 310 may be configured directly within an instance of the flexible DCI format 320, which reduces signaling overhead and configuration complexity, and increases adaptability relative mapping the functionalities 310 to the flexible DCI format 320 through a functionality group. For example, as shown in FIG. 2, the configuration may indicate a first flexible DCI format 320 associated with MIMO and downlink scheduling functionalities, a second flexible DCI format 320 associated with downlink scheduling and uplink scheduling functionalities, a third flexible DCI format 320 associated with uplink scheduling and BWP switching functionalities, and/or a fourth flexible DCI format 320 associated with BWP switching and SSSG switching functionalities. Furthermore, as shown, one or more flexible DCI formats 320 may include an identifier field (e.g., where the flexible DCI format 320 includes one or more fields that may apply to different functionalities 310), and padding is applied at a level of the flexible DCI format 320 to maintain a size alignment. For example, in FIG. 3, padding is applied to the instance of the flexible DCI format 320 associated with MIMO and downlink scheduling functionalities to ensure a size alignment with the flexible DCI format 320 associated with uplink scheduling and BWP switching functionalities. For example, applying padding to align DCI sizes may reduce the number of DCI sizes that the UE 120 monitors, which reduces complexity and increases resource efficiency (e.g., because DCI messages associate different DCI formats 320 can use the same resources).

In some aspects, reference number 330 provides an example RRC configuration for a flexible DCI format 320. For example, an instance of the flexible DCI format 320 is indicated by an RRC parameter, such as flexible-DCI, and the configuration for the instance of the flexible DCI format 320 may include an identifier, one or more functionalities 310 (e.g., up to a maximum number of functionalities 310), a cyclic redundancy check (CRC) length (e.g., having one of a set of enumerated values), and a total size (e.g., up to a maximum number of bits, such as 140 bits). In addition, the RRC configuration indicates the functionalities for the instance of the flexible DCI format 320, such as downlink scheduling (e.g., via a DL-Scheduling-Functionality parameter), MIMO (e.g., via a MIMO-Functionality parameter), and/or other parameters. In some aspects, the UE 120 may infer the number of padding bits from the total size of the flexible DCI format 320 and the size of the functionalities 310 that are configured for the flexible DCI format 320. Furthermore, in some examples, other techniques may be used to configure the instances of the flexible DCI format 320. For example, the RRC configuration may include a sequence of functionality identifiers, where each instance of a functionality configures the associated identifier, or the RRC configuration may use a “ToAddModList” mechanism defined for RRC parameters (e.g., where functionalities are defined for the ToAddModList parameter to dynamically adjust the functionalities that are associated with a flexible DCI format 320).

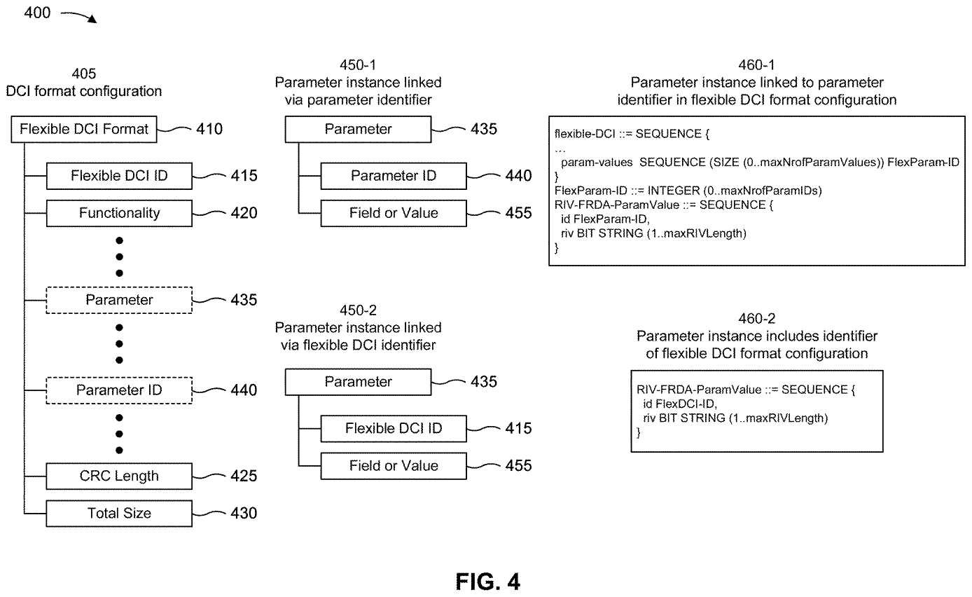

FIG. 4 illustrates examples 400 associated with a flexible DCI format configuration that indicates one or more functionalities. For example, as described herein, a functionality associated with a flexible DCI format may be used to indicate control information or configuration information related to communication or operation by the UE 120, such as downlink scheduling, uplink scheduling, sidelink scheduling, multicast scheduling, configuring MIMO operation, BWP switching, SSSG switching, TCI state change, PDCCH skipping, SCell dormancy, HARQ-acknowledgement codebook retransmission, PDCCH order triggering PRACH, SPS or CG release, SRS triggering, uplink TPC commands, indicating a slot format, or providing an indication related to an NES mode, among other examples. As described herein, each functionality is associated with a configuration condition, or concept requirements, that define minimum parameters to support the associated functionality.

In some aspects, a functionality that can be associated with the flexible DCI format configuration may be specified in a wireless communication standard, which may indicate the minimum parameters to implement the corresponding functionality. For example, the downlink scheduling functionality may be associated with a configuration condition that is satisfied when values for FDRA, TDRA, MCS, NDI, RV, HARQ process number, downlink assignment index (DAI), precoding resource indicator (PRI), K1 scheduling offset, and TPC for PUCCH parameters are provided. In another example, the uplink scheduling functionality may be associated with a configuration condition that is satisfied when values for FDRA, TDRA, MCS, NDI, RV, HARQ process number, frequency hopping flag, and TPC for PUCCH parameters are provided. In some examples, the size for one or more parameters associated with a functionality may be variable and determined according to one or more rules. For example, an FDRA field may be indicated by a bitmap that includes N_{RBG} bits in cases where a first resource allocation type (e.g., type 0) is configured, where N_{RBG} is a number of RB groups, or by a resource indication value (RIV) that includes

$$⌈ {log}_{2} ( {N}_{RB}^{DL , BWP} ( {N}_{R B}^{DL , BWP} + 1 ) / 2 ) ⌉ bits$$

in cases where a second resource allocation type (e.g., type 1) is configured, where

$${N}_{RB}^{DL , BWP}$$

is the number or RBs in a downlink BWP. Furthermore, the interpretation for a given field may vary depending on a configuration. For example, a TDRA field may be interpreted differently depending on whether a PDSCH time domain allocation list parameter is configured.

Accordingly, some aspects described herein relate to techniques to provide a configuration for an instance of a flexible DCI format that supports different parameters or parameter types to achieve a function for one or more fields. Furthermore, by supporting different parameters or parameter types to achieve a function for one or more fields, the configuration may be forward-compatible with new parameters that may be defined for later versions of a wireless communication standard. Furthermore, in some aspects, the configuration for the flexible DCI format may support omitting one or more parameters for a functionality (e.g., in cases where a default value is defined in a wireless communication standard) or there is only one configured candidate value (e.g., in a table) and the field size is dynamically calculated according to the number of configured candidate values. Accordingly, some aspects described herein, may provide forward-compatibility and flexibility to support new parameters that provide a parameter value, and support a reduced DCI size by omitting fields and still allowing different values to be configured for the omitted fields.

For example, in some aspects, a network node 110 may transmit, and a UE 120 may receive, a configuration for a flexible DCI format configuration 405, which configures an instance of the flexible DCI format 410 (referred to herein as “the flexible DCI format instance 410”). The flexible DCI format configuration 405 may optionally include an identifier 415 for the flexible DCI format instance 410, one or more functionalities 420 for the flexible DCI format instance 410, a CRC length indicator 425, and a total size indicator 430. In some aspects, the one or more functionalities 420 may each relate to a communication configuration, an operational configuration, or other control information to be applied by the UE 120. For example, the one or more functionalities 420 may include downlink scheduling, uplink scheduling, sidelink scheduling, multicast scheduling, configuring MIMO operation, BWP switching, SSSG switching, TCI state change, PDCCH skipping, SCell dormancy, HARQ-acknowledgement codebook retransmission, PDCCH order triggering PRACH, SPS or CG release, SRS triggering, uplink TPC commands, indicating a slot format, or providing an indication related to an NES mode, among other examples.

In some aspects, each functionality 420 configured for the instance of the flexible DCI format 405 is associated with a configuration condition, where the configuration condition (alternatively referred to as “concept requirements” or another term) defines a minimum set of parameters to achieve or otherwise implement the corresponding functionality 420. For example, as described herein, the downlink scheduling functionality may be associated with a configuration condition that is satisfied when the UE 120 is configured with respective values for FDRA, TDRA, MCS, NDI, RV, HARQ process number, DAI, PRI, K1 scheduling offset, and TPC for PUCCH parameters. In another example, the uplink scheduling functionality may be associated with a configuration condition that is satisfied when the UE 120 is configured with respective values for FDRA, TDRA, MCS, NDI, RV, HARQ process number, frequency hopping flag, and TPC for PUCCH parameters.

In some aspects, a parameter configuration that satisfies the configuration condition may be indicated as a field with a value that may be indicated in a DCI message associated with the instance of the DCI format configuration 405. For example, as described above, a configuration condition specified or otherwise defined for a functionality 420 related to uplink, downlink, sidelink, or multicast scheduling may include an FDRA parameter among the minimum set of parameters to be configured to enable the functionality 420, where the configuration condition related to the FDRA parameter may be satisfied by a RIV field that indicates an FDRA according to

$$⌈ {log}_{2} ( {N}_{RB}^{DL , BWP} ( {N}_{R B}^{DL , BWP} + 1 ) / 2 ) ⌉ bits$$

or a bitmap field that indicates an FDRA according to N_{RBG} bits. In cases where the configuration condition related to a parameter is satisfied by a field, the field may be indicated via RRC or other suitable signaling, and a DCI message associated with the flexible DCI format instance 410 may include the indicated field to provide a value for the appropriate parameter. Additionally, or alternatively, the configuration condition related to the FDRA parameter may be satisfied by a default value indicated in a wireless communication standard, by an RRC-configured value for the parameter (e.g., the network node 110 may provide a RIV-based FDRA value to satisfy the configuration condition related to the FDRA parameter), or other suitable configuration information.

Accordingly, as described herein, the configured flexible DCI format configuration 405 may support different parameter types to satisfy a configuration condition associated with a functionality 420 configured for a flexible DCI format instance 410. In this way, the flexible DCI format configuration 405 is forward-compatible with new parameters that may be developed in the future without any change to existing information elements (IEs) or the flexible DCI format configuration 405. In some aspects, as shown in the flexible DCI format configuration 405, the field or value that satisfies the configuration condition for a functionality 420 may be configured as a parameter 435 within the configuration for the flexible DCI format instance 410. For example, to satisfy the configuration condition for the FDRA parameter, the flexible DCI format instance 410 may include a parameter 435 that indicates a RIV-based FDRA field, an FDRA bitmap field, a value for a RIV-based FDRA, or a value for an FDRA bitmap. In some aspects, in cases where the UE 120 is configured with multiple flexible DCI format instances 410 that are otherwise identical except configured with a different value for one or more parameters 435 (e.g., a first flexible DCI format instance 410 includes a parameter 435 that indicates a RIV-based FDRA value and a second flexible DCI format instance 410 includes a parameter 435 that indicates a bitmap-based FDRA value), the otherwise identical flexible DCI format instances 410 include respective identifiers 415 that are transmitted in DCI messages associated with the flexible DCI format instances 410.

Alternatively, in some aspects, the field or value that satisfies the configuration condition for a functionality 420 may be configured as a parameter 435 separate from the configuration for the flexible DCI format instance 410, and the parameter 435 may be linked to the flexible DCI format instance 410 by an identifier. For example, as shown by reference number 450-1, the configuration for the parameter 435 may include a parameter identifier 440 and an indication of the field or value that satisfies the configuration condition, and the parameter identifier 440 may be included in the configuration for the flexible DCI format instance 410. For example, reference number 460-1 depicts an example configuration where a parameter instance is linked to an identifier for the parameter instance in the flexible DCI format configuration. As shown, the flexible DCI format configuration indicates one or more parameter values (e.g., param-values), up to a maximum number of parameter values and a parameter identifier (e.g., FlexParam-ID). As further shown, a configuration for a parameter instance includes the parameter identifier and the associated field or value.

Alternatively, as shown by reference number 450-2, the configuration for the flexible DCI format instance 410 includes an identifier 415 for the flexible DCI format instance 410, and the configuration for the parameter 435 includes the identifier 415 for the flexible DCI format instance 410 and an indication of the field or value that satisfies the configuration condition. For example, reference number 460-2 depicts an example configuration where a parameter instance includes the identifier of the flexible DCI format instance and indicates the associated field or value for the parameter 435.

Accordingly, as described herein, the UE 120 may determine whether the configuration condition(s) for each functionality 420 associated with a flexible DCI format instance 410 are satisfied, and may monitor one or more PDCCH candidates for a DCI message associated with the flexible DCI format instance 410 in accordance with the configuration condition(s) for each functionality 420 associated with a flexible DCI format instance 410 being satisfied. For example, in some aspects, the one or more PDCCH candidates may be identified in a search space configuration associated with the flexible DCI format instance 410, as described in more detail below with reference to FIG. 4. Furthermore, to support error handling for the flexible DCI format, the UE 120 is not expected to be configured with a flexible DCI format instance 410 that does not fully satisfy the configuration condition(s) for each functionality 420 associated with a flexible DCI format instance 410. In addition, the UE 120 is not expected to be configured with a flexible DCI format instance 410 that includes multiple fields or values that satisfy the configuration condition for one or more functionalities 420 associated with a flexible DCI format instance 410. For example, a flexible DCI format instance 410 associated with a functionality 420 that requires an FDRA configuration may be deemed invalid in cases where a field or value that satisfies the FDRA configuration is not configured or indicated, or in cases where multiple fields or values that satisfy the FDRA configuration are configured or indicated (e.g., a first parameter instance 435 configures a RIV-based FDRA and a second parameter instance 435 configures a bitmap-based FDRA). In such cases, where the flexible DCI format instance 410 is misconfigured or otherwise invalid, the UE 120 may refrain from monitoring PDCCH candidates associated with the flexible DCI format instance 410.

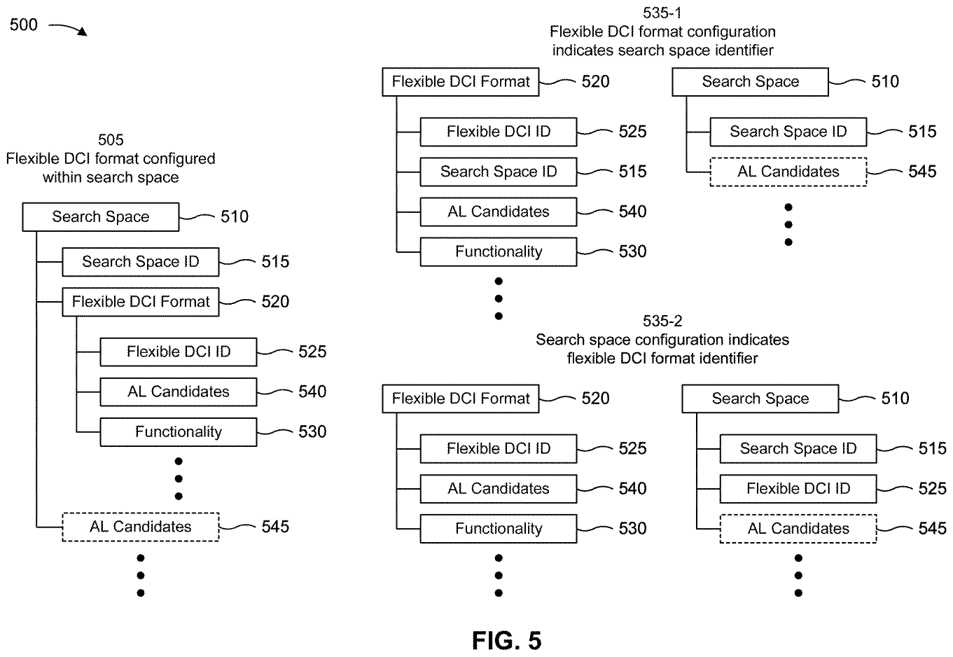

FIG. 5 illustrates examples 500 associated with a flexible DCI format configuration associated with a search space. In some aspects, the features described related to the search space configuration associated with a flexible DCI format instance may be implemented in combination with the aspects described with respect to FIG. 4. In some aspects, as described herein, one or more flexible DCI format instances may be configured per search space, where different flexible DCI format instances configured within the same search space may have different functionalities and/or different parameters that satisfy one or more of the same functionalities.

For example, as shown by reference number 505, a configuration for a search space 510 may include an identifier 515 for the search space and one or more flexible DCI format instances 520 that are configured within the search space 510. In some aspects, one or more of the flexible DCI format instances 520 may optionally include an identifier 525 (e.g., to link a parameter configuration or differentiate an otherwise identical flexible DCI format instance 520 that uses a different field or parameter value to satisfy the same configuration condition). In some aspects, the flexible DCI format instances 520 each include one or more functionalities 530, as described in more detail elsewhere herein, where the flexible DCI format instances 520 configured within the search space 510 may have different functionalities 530 and/or different parameters that satisfy one or more of the same functionalities 530.

Alternatively, in some aspects, a configuration for a search space 510 may be linked to one or more flexible DCI format instances 520 via an identifier. For example, as shown by reference number 535-1, a flexible DCI format instance 520 and the search space 510 are associated with separate configurations, and the identifier 515 for the search space is included in the configuration for the flexible DCI format instance 520. Alternatively, as shown by reference number 535-2, a flexible DCI format instance 520 and the search space 510 are associated with separate configurations, and the identifier 525 for the flexible DCI format instance 520 is included in the configuration for the search space 510. The search space 510 may include parameters for one or more SSSGs, BWPs, and/or cells, and one or more identifiers 525 for one or more flexible DCI format instances 520 may be configured per SSSG, BWP, and/or cell.

In some aspects, as shown, a configuration for a search space 510 may optionally include a configuration for aggregation level (AL) PDCCH candidates, where aggregation level PDCCH candidates configured at a search space level generally apply to all DCI formats that are monitored in the search space. For example, a configuration for a search space 510 may indicate aggregation level candidates 545 (e.g., nrofCandidates) to indicate a number of PDCCH candidates per aggregation level (e.g., 0, 1, 2, 3, 4, 5, 6, 8, or another number of PDCCH candidates for aggregation levels of 1, 2, 4, 8, and/or 16). Accordingly, in cases where the search space 510 indicates the aggregation level candidates 545 applicable to all DCI formats that are monitored in the search space 510, multiple search spaces 510 need to be configured and active in order to limit one or more DCI formats to one or more aggregation levels. Accordingly, to provide more flexibility for the aggregation levels associated with a flexible DCI format instance 520, the configuration for a flexible DCI format instance 520 indicates aggregation level candidates 540 to be monitored for the flexible DCI format instance 520. In some aspects, the aggregation level candidates 540 that are configured for the flexible DCI format instance 520 may supplement the aggregation level candidates 545 configured for the search space 510 (e.g., the UE 120 may monitor the aggregation level candidates 540 configured for the flexible DCI format instance 520 and the aggregation level candidates 545 configured for the search space 510 for DCI messages associated with the flexible DCI format instance 520). Alternatively, the aggregation level candidates 540 that are configured for the flexible DCI format instance 520 may override the aggregation level candidates 545 configured for the search space 510 (e.g., the UE 120 may monitor only the aggregation level candidates 540 configured for the flexible DCI format instance 520 for DCI messages associated with the flexible DCI format instance 520, and may monitor the aggregation level candidates 545 configured for the search space 510 only for other DCI formats associated with the search space 510). Alternatively, in some aspects, the configuration for aggregation level candidates 545 may be omitted from the configuration for the search space 510.

FIG. 6 is a diagram illustrating an example process 600 performed, for example, at a UE or an apparatus of a UE. Example process 600 is an example where the apparatus or the UE (e.g., UE 120) performs operations associated with a flexible DCI format.

As shown in FIG. 6, in some aspects, process 600 may include receiving, from a network node, a configuration that indicates a functionality for a DCI format configuration, the functionality associated with a configuration condition (block 610). For example, the UE (e.g., using reception component 802 or communication manager 806, depicted in FIG. 8) may receive, from a network node, a configuration that indicates a functionality for a DCI format configuration, the functionality associated with a configuration condition, as described above.

As further shown in FIG. 6, in some aspects, process 600 may include monitoring a PDCCH candidate for a DCI message associated with the DCI format configuration based on whether the configuration satisfies the configuration condition associated with the functionality (block 620). For example, the UE (e.g., using communication manager 806, depicted in FIG. 8) may monitor a PDCCH candidate for a DCI message associated with the DCI format configuration based on whether the configuration satisfies the configuration condition associated with the functionality, as described above.

Process 600 may include additional aspects, such as any single aspect or any combination of aspects described below or in connection with one or more other processes described elsewhere herein.

In a first aspect, the configuration indicates a DCI field that satisfies the configuration condition associated with the functionality.

In a second aspect, alone or in combination with the first aspect, the configuration indicates a parameter value that satisfies the configuration condition associated with the functionality.

In a third aspect, alone or in combination with one or more of the first and second aspects, the DCI format configuration is associated with a search space that includes the PDCCH candidate.

In a fourth aspect, alone or in combination with one or more of the first through third aspects, the configuration indicates the DCI format configuration in a configuration for a search space.

In a fifth aspect, alone or in combination with one or more of the first through fourth aspects, the configuration indicates one or more of an identifier for the DCI format configuration in a configuration for a search space or an identifier for a search space in the DCI format configuration.

In a sixth aspect, alone or in combination with one or more of the first through fifth aspects, the DCI format configuration indicates one or more parameter values that satisfy the configuration condition associated with the functionality.

In a seventh aspect, alone or in combination with one or more of the first through sixth aspects, process 600 includes receiving, via the PDCCH candidate, a DCI message that includes an identifier associated with the DCI format configuration.

In an eighth aspect, alone or in combination with one or more of the first through seventh aspects, the configuration indicates a parameter value that satisfies the configuration condition associated with the functionality, and the DCI format configuration includes an identifier for the parameter value.

In a ninth aspect, alone or in combination with one or more of the first through eighth aspects, the configuration indicates a parameter value that satisfies the configuration condition associated with the functionality, the parameter value associated with an identifier for the DCI format configuration.

In a tenth aspect, alone or in combination with one or more of the first through ninth aspects, the DCI format configuration indicates one or more aggregation levels to monitor for the PDCCH candidate.

In an eleventh aspect, alone or in combination with one or more of the first through tenth aspects, the one or more aggregation levels indicated in the DCI format configuration are in addition to one or more aggregation levels configured for a search space that includes the PDCCH candidate.

In a twelfth aspect, alone or in combination with one or more of the first through eleventh aspects, the one or more aggregation levels indicated in the DCI format configuration override one or more aggregation levels configured for a search space that includes the PDCCH candidate.

In a thirteenth aspect, alone or in combination with one or more of the first through twelfth aspects, a configuration for a search space that includes the PDCCH candidate omits a configuration for one or more aggregation levels.

In a fourteenth aspect, alone or in combination with one or more of the first through thirteenth aspects, monitoring the PDCCH candidate for the DCI message associated with the DCI format configuration includes refraining from monitoring the PDCCH candidate for the DCI message associated with the DCI format configuration based on the configuration failing to satisfy the configuration condition associated with the functionality.

In a fifteenth aspect, alone or in combination with one or more of the first through fourteenth aspects, monitoring the PDCCH candidate for the DCI message associated with the DCI format configuration includes refraining from monitoring the PDCCH candidate for the DCI message associated with the DCI format configuration based on the configuration including first information and second information that satisfies the configuration condition associated with the functionality.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with DCI format.

As shown in FIG. 7, in some aspects, process 700 may include transmitting, to a UE, a configuration that indicates a functionality for a DCI format configuration, wherein the configuration indicates one or more fields or values that satisfy a configuration condition associated with the functionality (block 710). For example, the network node (e.g., using transmission component 904 or communication manager 906, depicted in FIG. 9) may transmit, to a UE, a configuration that indicates a functionality for a DCI format configuration, wherein the configuration indicates one or more fields or values that satisfy a configuration condition associated with the functionality, as described above.

As further shown in FIG. 7, in some aspects, process 700 may include transmitting, to the UE via a PDCCH candidate, a DCI message associated with the DCI format configuration (block 720). For example, the network node (e.g., using transmission component 904 or communication manager 906, depicted in FIG. 9) may transmit, to the UE via a PDCCH candidate, a DCI message associated with the DCI format configuration, as described above.

Process 700 may include additional aspects, such as any single aspect or any combination of aspects described below or in connection with one or more other processes described elsewhere herein.

In a first aspect, the configuration indicates a DCI field that satisfies the configuration condition associated with the functionality.

In a second aspect, alone or in combination with the first aspect, the configuration indicates a parameter value that satisfies the configuration condition associated with the functionality.

In a third aspect, alone or in combination with one or more of the first and second aspects, the DCI format configuration is associated with a search space that includes the PDCCH candidate.

In a fourth aspect, alone or in combination with one or more of the first through third aspects, the configuration indicates the DCI format configuration in a configuration for a search space.

In a fifth aspect, alone or in combination with one or more of the first through fourth aspects, the configuration indicates one or more of an identifier for the DCI format configuration in a configuration for a search space or an identifier for a search space in the DCI format configuration.

In a sixth aspect, alone or in combination with one or more of the first through fifth aspects, the DCI format configuration indicates one or more parameter values that satisfy the configuration condition associated with the functionality.

In a seventh aspect, alone or in combination with one or more of the first through sixth aspects, process 700 includes transmitting, via the PDCCH candidate, a DCI message that includes an identifier associated with the DCI format configuration.

In an eighth aspect, alone or in combination with one or more of the first through seventh aspects, the configuration indicates a parameter value that satisfies the configuration condition associated with the functionality, and the DCI format configuration includes an identifier for the parameter value.

In a ninth aspect, alone or in combination with one or more of the first through eighth aspects, the configuration indicates a parameter value that satisfies the configuration condition associated with the functionality, the parameter value associated with an identifier for the DCI format configuration.

In a tenth aspect, alone or in combination with one or more of the first through ninth aspects, the DCI format configuration indicates one or more aggregation levels to monitor for the PDCCH candidate.

In an eleventh aspect, alone or in combination with one or more of the first through tenth aspects, the one or more aggregation levels indicated in the DCI format configuration are in addition to one or more aggregation levels configured for a search space that includes the PDCCH candidate.

In a twelfth aspect, alone or in combination with one or more of the first through eleventh aspects, the one or more aggregation levels indicated in the DCI format configuration override one or more aggregation levels configured for a search space that includes the PDCCH candidate.

In a thirteenth aspect, alone or in combination with one or more of the first through twelfth aspects, a configuration for a search space that includes the PDCCH candidate omits a configuration for one or more aggregation levels.

In a fourteenth aspect, alone or in combination with one or more of the first through thirteenth aspects, monitoring the PDCCH candidate for the DCI message associated with the DCI format configuration includes refraining from monitoring the PDCCH candidate for the DCI message associated with the DCI format configuration based on the configuration failing to satisfy the configuration condition associated with the functionality.

In a fifteenth aspect, alone or in combination with one or more of the first through fourteenth aspects, monitoring the PDCCH candidate for the DCI message associated with the DCI format configuration includes refraining from monitoring the PDCCH candidate for the DCI message associated with the DCI format configuration based on the configuration including first information and second information that satisfies the configuration condition associated with the functionality.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE 120, or a UE 120 may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE 120.

In some aspects, the apparatus 800 may be configured to perform one or more operations described herein in connection with FIGS. 2-5. Additionally, or alternatively, the apparatus 800 may be configured to perform one or more processes described herein, such as process 600 of FIG. 6. In some aspects, the apparatus 800 or one or more components shown in FIG. 8 may include one or more components of the UE 120 described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE 120 described above in connection with FIG. 1, such as a radio, one or more RF chains, one or more transceivers, or one or more modems, each of which may in turn be coupled with one or more antennas of the UE 120.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, from a network node, a configuration that indicates a functionality for a DCI format configuration, the functionality associated with a configuration condition. The reception component 802 and/or the communication manager 806 may monitor a PDCCH candidate for a DCI message associated with the DCI format configuration based on whether the configuration satisfies the configuration condition associated with the functionality.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node 110, or a network node 110 may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node 110.

In some aspects, the apparatus 900 may be configured to perform one or more operations described herein in connection with FIGS. 2-5. Additionally, or alternatively, the apparatus 900 may be configured to perform one or more processes described herein, such as process 700 of FIG. 7. In some aspects, the apparatus 900 or one or more components shown in FIG. 9 may include one or more components of the network node 110 described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node 110 described above in connection with FIG. 1, such as a radio, one or more RF chains, one or more transceivers, or one or more modems, each of which may in turn be coupled with one or more antennas of the network node 110. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node 110 described above in connection with FIG. 1, such as a radio, one or more RF chains, one or more transceivers, or one or more modems, each of which may in turn be coupled with one or more antennas of the network node 110 described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a UE, a configuration that indicates a functionality for a DCI format configuration, wherein the configuration indicates one or more fields or values that satisfy a configuration condition associated with the functionality. The transmission component 904 may transmit, to the UE via a PDCCH candidate, a DCI message associated with the DCI format configuration.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving, from a network node, a configuration that indicates a functionality for a DCI format configuration, the functionality associated with a configuration condition; and monitoring a PDCCH candidate for a DCI message associated with the DCI format configuration based on whether the configuration satisfies the configuration condition associated with the functionality.

Aspect 2: The method of Aspect 1, wherein the configuration indicates a DCI field that satisfies the configuration condition associated with the functionality.

Aspect 3: The method of any of Aspects 1-2, wherein the configuration indicates a parameter value that satisfies the configuration condition associated with the functionality.

Aspect 4: The method of any of Aspects 1-3, wherein the DCI format configuration is associated with a search space that includes the PDCCH candidate.

Aspect 5: The method of any of Aspects 1-4, wherein the configuration indicates the DCI format configuration in a configuration for a search space.

Aspect 6: The method of any of Aspects 1-5, wherein the configuration indicates one or more of an identifier for the DCI format configuration in a configuration for a search space or an identifier for a search space in the DCI format configuration.

Aspect 7: The method of any of Aspects 1-6, wherein the DCI format configuration indicates one or more parameter values that satisfy the configuration condition associated with the functionality.

Aspect 8: The method of any of Aspects 1-7, further comprising: receiving, via the PDCCH candidate, a DCI message that includes an identifier associated with the DCI format configuration.

Aspect 9: The method of any of Aspects 1-8, wherein the configuration indicates a parameter value that satisfies the configuration condition associated with the functionality, and the DCI format configuration includes an identifier for the parameter value.

Aspect 10: The method of any of Aspects 1-9, wherein the configuration indicates a parameter value that satisfies the configuration condition associated with the functionality, the parameter value associated with an identifier for the DCI format configuration.

Aspect 11: The method of any of Aspects 1-10, wherein the DCI format configuration indicates one or more aggregation levels to monitor for the PDCCH candidate.

Aspect 12: The method of Aspect 11, wherein the one or more aggregation levels indicated in the DCI format configuration are in addition to one or more aggregation levels configured for a search space that includes the PDCCH candidate.

Aspect 13: The method of Aspect 11, wherein the one or more aggregation levels indicated in the DCI format configuration override one or more aggregation levels configured for a search space that includes the PDCCH candidate.

Aspect 14: The method of Aspect 11, wherein a configuration for a search space that includes the PDCCH candidate omits a configuration for one or more aggregation levels.

Aspect 15: The method of any of Aspects 1-14, wherein monitoring the PDCCH candidate for the DCI message associated with the DCI format configuration includes: refraining from monitoring the PDCCH candidate for the DCI message associated with the DCI format configuration based on the configuration failing to satisfy the configuration condition associated with the functionality.

Aspect 16: The method of any of Aspects 1-15, wherein monitoring the PDCCH candidate for the DCI message associated with the DCI format configuration includes: refraining from monitoring the PDCCH candidate for the DCI message associated with the DCI format configuration based on the configuration including first information and second information that satisfies the configuration condition associated with the functionality.

Aspect 17: A method of wireless communication performed by a network node, comprising: transmitting, to a UE, a configuration that indicates a functionality for a DCI format configuration, wherein the configuration indicates one or more fields or values that satisfy a configuration condition associated with the functionality; and transmitting, to the UE via a PDCCH candidate, a DCI message associated with the DCI format configuration.

Aspect 18: The method of Aspect 17, wherein the configuration indicates a DCI field that satisfies the configuration condition associated with the functionality.

Aspect 19: The method of any of Aspects 17-18, wherein the configuration indicates a parameter value that satisfies the configuration condition associated with the functionality.

Aspect 20: The method of any of Aspects 17-19, wherein the DCI format configuration is associated with a search space that includes the PDCCH candidate.

Aspect 21: The method of any of Aspects 17-20, wherein the configuration indicates the DCI format configuration in a configuration for a search space.

Aspect 22: The method of any of Aspects 17-21, wherein the configuration indicates one or more of an identifier for the DCI format configuration in a configuration for a search space or an identifier for a search space in the DCI format configuration.

Aspect 23: The method of any of Aspects 17-22, wherein the DCI format configuration indicates one or more parameter values that satisfy the configuration condition associated with the functionality.

Aspect 24: The method of any of Aspects 17-23, further comprising: transmitting, via the PDCCH candidate, a DCI message that includes an identifier associated with the DCI format configuration.

Aspect 25: The method of any of Aspects 17-24, wherein the configuration indicates a parameter value that satisfies the configuration condition associated with the functionality, and the DCI format configuration includes an identifier for the parameter value.

Aspect 26: The method of any of Aspects 17-25, wherein the configuration indicates a parameter value that satisfies the configuration condition associated with the functionality, the parameter value associated with an identifier for the DCI format configuration.

Aspect 27: The method of any of Aspects 17-26, wherein the DCI format configuration indicates one or more aggregation levels to monitor for the PDCCH candidate.

Aspect 28: The method of Aspect 27, wherein the one or more aggregation levels indicated in the DCI format configuration are in addition to one or more aggregation levels configured for a search space that includes the PDCCH candidate.

Aspect 29: The method of Aspect 27, wherein the one or more aggregation levels indicated in the DCI format configuration override one or more aggregation levels configured for a search space that includes the PDCCH candidate.

Aspect 30: The method of Aspect 27, wherein a configuration for a search space that includes the PDCCH candidate omits a configuration for one or more aggregation levels.

Aspect 31: The method of any of Aspects 17-30, wherein monitoring the PDCCH candidate for the DCI message associated with the DCI format configuration includes: refraining from monitoring the PDCCH candidate for the DCI message associated with the DCI format configuration based on the configuration failing to satisfy the configuration condition associated with the functionality.

Aspect 32: The method of any of Aspects 17-31, wherein monitoring the PDCCH candidate for the DCI message associated with the DCI format configuration includes: refraining from monitoring the PDCCH candidate for the DCI message associated with the DCI format configuration based on the configuration including first information and second information that satisfies the configuration condition associated with the functionality.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

Aspect 40: A device comprising a processing system that includes one or more processors and one or more code-storing memories coupled with the one or more processors, the processing system configured to cause the device to perform the method of one or more of Aspects 1-32.

Aspect 41: A device comprising a processing system that includes processor circuitry and code-storing memory circuitry, the processing system configured to cause the device to perform the method of one or more of Aspects 1-32.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a configuration that indicates a functionality for a downlink control information (DCI) format configuration, the functionality associated with a configuration condition; and
monitor a physical downlink control channel (PDCCH) candidate for a DCI message associated with the DCI format configuration based on whether the configuration satisfies the configuration condition associated with the functionality.

2. The UE of claim 1, wherein the configuration indicates a DCI field that satisfies the configuration condition associated with the functionality.

3. The UE of claim 1, wherein the configuration indicates a parameter value that satisfies the configuration condition associated with the functionality.

4. The UE of claim 1, wherein the DCI format configuration is associated with a search space that includes the PDCCH candidate.

5. The UE of claim 1, wherein the configuration indicates the DCI format configuration in a configuration for a search space.

6. The UE of claim 1, wherein the configuration indicates one or more of an identifier for the DCI format configuration in a configuration for a search space or an identifier for a search space in the DCI format configuration.

7. The UE of claim 1, wherein the DCI format configuration indicates one or more parameter values that satisfy the configuration condition associated with the functionality.

8. The UE of claim 1, wherein the processing system is further configured to cause the UE to:
receive, via the PDCCH candidate, a DCI message that includes an identifier associated with the DCI format configuration.

9. The UE of claim 1, wherein the configuration indicates a parameter value that satisfies the configuration condition associated with the functionality, and the DCI format configuration includes an identifier for the parameter value.

10. The UE of claim 1, wherein the configuration indicates a parameter value that satisfies the configuration condition associated with the functionality, the parameter value associated with an identifier for the DCI format configuration.

11. The UE of claim 1, wherein the DCI format configuration indicates one or more aggregation levels to monitor for the PDCCH candidate.

12. The UE of claim 11, wherein the one or more aggregation levels indicated in the DCI format configuration are in addition to one or more aggregation levels configured for a search space that includes the PDCCH candidate.

13. The UE of claim 11, wherein the one or more aggregation levels indicated in the DCI format configuration override one or more aggregation levels configured for a search space that includes the PDCCH candidate.

14. The UE of claim 11, wherein a configuration for a search space that includes the PDCCH candidate omits a configuration for one or more aggregation levels.

15. The UE of claim 1, wherein to monitor the PDCCH candidate for the DCI message associated with the DCI format configuration, the processing system is configured to cause the UE to:
refrain from monitoring the PDCCH candidate for the DCI message associated with the DCI format configuration based on the configuration failing to satisfy the configuration condition associated with the functionality.

16. The UE of claim 1, wherein to monitor the PDCCH candidate for the DCI message associated with the DCI format configuration, the processing system is configured to cause the UE to:
refrain from monitoring the PDCCH candidate for the DCI message associated with the DCI format configuration based on the configuration including first information and second information that satisfies the configuration condition associated with the functionality.

17. A network node, comprising:
a processing system that includes one or more processors and one or more code-storing memories coupled with the one or more processors, the processing system configured to cause the network node to:
transmit, to a user equipment (UE), a configuration that indicates a functionality for a downlink control information (DCI) format configuration, wherein the configuration indicates one or more fields or values that satisfy a configuration condition associated with the functionality; and
transmit, to the UE via a physical downlink control channel (PDCCH) candidate, a DCI message associated with the DCI format configuration.

18. The network node of claim 17, wherein the configuration indicates a parameter value that satisfies the configuration condition associated with the functionality.

19. The network node of claim 17, wherein the DCI format configuration is associated with a search space that includes the PDCCH candidate.

20. A method of wireless communication performed by a user equipment (UE), comprising:
receiving, from a network node, a configuration that indicates a functionality for a downlink control information (DCI) format configuration, the functionality associated with a configuration condition; and
monitoring a physical downlink control channel (PDCCH) candidate for a DCI message associated with the DCI format configuration based on whether the configuration satisfies the configuration condition associated with the functionality.
